(19) United States
(12) Patent Application Publication
(10) Pub. No.: US 2002/0114078 A1
(43) Pub. Date: Aug. 22, 2002

(54) Resolution modulation in microlens image reproduction

(76) Inventors: Michael Halle, Cambridge, MA (US); Stephen Daniell, Easthampton, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/021,743

(22) Filed: Dec. 12, 2001

Related U.S. Application Data
(60) Provisional application No. 60/255,337, filed on Dec. 13, 2000.
(60) Provisional application No. 60/293,095, filed on May 23, 2001.

(51) Int. Cl. G02B 27/10

(52) U.S. Cl. 359/619; 359/621; 359/622; 359/623

(57) ABSTRACT

Lens arrays facilitate intermodulation of spatial and angular resolutions. The arrays are configured to have observable spatial resolutions significantly different from (and generally higher than) the pitch of the lens array, and may be used, for example, be used to simulate three-dimensional scenes.

### RELATED APPLICATION

This application claims the benefits of U.S. Provisional Application Serial Nos. 60/255,337, filed on Dec. 13, 2000 and 60/293,095, filed on May 23, 2001, the entire disclosures of which are hereby incorporated by reference.

### FIELD OF THE INVENTION

The present invention relates to lens arrays, and in particular to surfaces that present a differing aspect depending on the relative angular position of a viewer.

### BACKGROUND OF THE INVENTION

A stereoscopic image is created by the presentation of optically separate views of the same scene. An autostereoscopic image optically separates differing views by an optical mechanism near or behind the image surface. A viewer in such cases is not required to wear glasses, goggles, or other devices near the eyes to integrate the images. Examples of autostereoscopic systems include holograms, barrier displays, lenticular images, and microlens images.

Traditional lenticular lens arrays have been designed with relatively little attention to the depth at which each lens focuses light in front of the lens array. Two configurations commonly exist, each created based on a conjecture as to how light should exist the lens array. For various reasons, existing lens array systems produce suboptimal three-dimensional images.

In the more common configuration, the vertical focus of the lens array is placed at infinity; thus, the lenses function as collimators. This configuration is based on the idea that each lens should map the position of a picture element (or “pixel”) of information on its backplane (i.e., the image surface) uniquely to the single direction of a “bundle” of rays of light leaving the lens. In a less common configuration, the lens focus is moved to the approximate and intended location of the ocular pupils of a hypothetical human observer. In the latter case, when viewed from the correct view distance, the width of each lens will appear to be a single color, since each part of a given lens is sending light towards the viewer's eye from a common point of optical origin. In this mode, the lens can be thought of as similar to a monochrome pixel of an image, although each pixel varies in appearance when viewed from different angles. In instances where integral photographs or microlens displays (two-dimensional lens arrays) have been implemented, an afocal array operation has been presumed, as it had been in lenticular arrays.

Lenticular display systems are based on one-dimensional lenses that are inherently astigmatic. This astigmatism leads to a display that is relatively difficult to spatially analyze from a three-dimensional imaging perspective, since the horizontal and vertical directions must be considered separately. One focus is fixed on the backplane of the lenses and the other is located at a single depth in space. As a result, neither focus exactly recreates the appearance of a general three-dimensional object. The accommodation depth sense therefore cannot be correctly stimulated in this case.

Arrays of two-dimensional microlenses have been employed to create simulated three-dimensional images by the process of “integral imaging.” Each lens of the array is typically devised to essentially act as an afocal optical system, in which a point source produced at the image plane does not significantly converge unless brought into focus by the eye or an optical device. (In a focal system having finite conjugates, by contrast, a point emission produced at the image plane converges at a relatively distant conjugate point outside the array.) Such afocal microlens systems have been either collimators, which emulate an infinite focal distance, or have focused at the intended view distance.

Several color or tone elements are located at the focal plane of each afocal microlens, which infinitely magnifies only one of the color or tone elements at a time; again, each lens acts as a discrete pixel, displaying a monochromatic spot. The set of spots reproduced by the array and perceived by the viewer defines the image. The particular color or tone element reproduced by the lens depends on the viewer's angle with respect to the lens. As a result, the viewer will see different patterns of spots—i.e., different images—at spatially separated locations; the contents of these images, in turn, are dictated by the arrangement of color or tone elements accessible to each microlens. When the color or tone elements are arranged so as to provide compatible binocular views, an autostereoscopic image may be seen. In the conventional understanding, each lens therefore acts as a pixel in the image, but has an additional property to the extent that its graphic aspect varies with the angle of view. As a result, the number of pixels in any viewed image is always equal to (or at least cannot exceed) the number of lenses.

Consequently, an autostereoscopic image may be considered to have three distinct types of resolution. Total graphic resolution refers to the total number of picture elements contained in an image. The observed spatial resolution is analogous to conventional image resolution, defining the spatial frequency of the picture elements image. However, in a stereoscopic image, the observed spatial resolution is most accurately taken at the apparent location in space at which the eyes adapt to best resolve the dimensional image, rather than at the physical surface of a particular display element. In traditional microlens systems, the spatial resolution does not exceed the lens pitch. The observed angular resolution defines the angular frequency with which a typical image element is replaced with another image element having differing visual contents. In other words, the higher the angular resolution, the smaller the distance a viewer must move to perceive a new image.

In an optically ideal autostereoscopic system, the total graphic resolution may be considered to be the mathematical product of the observed spatial resolution and the observed angular resolution. The total graphic resolution is limited in theory by the space-bandwidth product of the given area of graphic material.

The spatial resolution of presently available microlens-based reproduction systems is limited to the number of lenses in the array; that is, the number of pixels defining the image is equal to the number of lenses.

### DESCRIPTION OF THE INVENTION

### Brief Summary of the Invention

In accordance with the present invention, a lens array is configured to have an observable spatial resolution significantly different from (and generally higher than) the pitch of the lens array employed. The display may, for example, be used to simulate three-dimensional scenes.

More specifically, in visually variable, microlens-based displays (such as autostereoscopic systems) in accordance with the invention, the election of a particular magnification can be used to intermodulate the spatial and angular resolutions of a display. It can also be used to locate apparent sources of light at a predetermined distance in front of the array to produce visually naturalistic aerial images. An aerial or “floating” image appears suspended ahead of the actual physical location of the picture elements, and can be produced, for example, by focal lens systems, since the eyes of a human observer can be made to both accommodate and converge on this location in free space. Suitable focal lens systems are described in copending application Ser. Nos. 09/811,212 (filed Mar. 16, 2001), 09/811,298 and 09/811,301 (both filed Mar. 17, 2001) and published PCT application no. WO 01/71410 (filed Mar. 16, 2001); the entire disclosures of these publications are hereby incorporated by reference.

In a preferred embodiment, the present invention utilizes finite-conjugate geometry that allows microimages to be projected to form overlapping real images at a range of magnifications, thereby facilitating intermodulation of the observed spatial and angular resolutions. Within the limits of the array optics, the total resolution may be divided between the angular resolution and the spatial resolution. In a focal optical arrangement according to the invention, the observed spatial resolution may be substantially greater than the physical pitch of the lenses in the array.

Also, the focus of both lenticular (one-dimensional) and microlens (two-dimensional) lens array displays can be moved away from the conventional locations in order to optimize the design of the display so as to match the characteristics of the object being displayed and the display itself. The factors involved include the design of lens array, the resolution of the image recorded on its backplane, and the three-dimensional resolution of the object being displayed.

In accordance with the invention, lenticular images can include animation instead of, or in addition to, stereoscopic information. Lens arrays constructed in accordance herewith can provide depth and animation together, with little visual ambiguity. The impact of aerial image overlap on image animation is straightforward: the more distinct ray directions that pass through a point on the finite-conjugate image field (with one ray direction corresponding to each lens), the more frames of animation that can be displayed.

The dissociation of the image resolution from the pitch of the lens array can greatly enhance the subjective appearance of an image by allowing a higher net spatial resolution for a given microlens device. This permits accommodative depth cues to conform to locations in front of displays, and can reduce tolerance constraints and the manufacturing complexities associated with microlenses. When arrays are formed of polymers, images of diverse resolutions and graphic properties may be produced from a single set of mold inserts.

Accordingly, in a first aspect, the invention comprises a lens array that includes an array of lens elements having a backplane for reproducing an image located at the backplane. Each lens has a nonunitary magnification and reproduces visual information from the backplane to a finite conjugate region in free space such that the reproduced visual information overlaps with visual information reproduced in free space by at least one neighboring lens element. The visual information may, for example, be reproduced by the lens elements as a stereoscopic image.

In preferred embodiments, the lens elements cooperate to reproduce an image having a spatial resolution distinct from (e.g., greater than) the lens pitch. The lens elements may cooperate to project a finite conjugate field to a series of curved quadratic surfaces in free space, forming a mosaic virtual field having locally varying spatial and angular resolutions. The residual field curvature may vary locally in magnification to facilitate visual decorrelation of images individually produced by the lens elements.

In a second aspect, the invention comprises a method of producing an aerial image in free space. The image has a spatial resolution and varying with viewing angle according to an angular resolution, and in accordance with the method, a lens array comprising an array of lens elements having a backplane and a nonunitary magnification is provided. The lens array reproduces visual information to a finite conjugate region in free space, the spatial and angular resolutions of the image vary with the magnifications of the lens elements, and visual information reproduced at the finite conjugate region by each lens element overlaps with visual information reproduced at the finite conjugate region by at least one neighboring lens element. In accordance with the method, a magnification corresponding to a predetermined angular and spatial image resolution is selected.

### BRIEF DESCRIPTION OF THE DRAWINGS

The foregoing discussion will be understood more readily from the following detailed description of the invention, when taken in conjunction with the accompanying drawings, in which:

FIG. 1 is a front elevation of a microlens array having predominantly hexagonal emission apertures;

FIG. 2 is a schematic top view of the lens array shown in FIG. 1 operating in focal mode, providing finite conjugates in the free space ahead of the array;

FIG. 3 schematically depicts a plurality of optical sources intersecting a common location in free space;

FIG. 4 schematically depicts an observer viewing point emission from a real object;

FIG. 5 illustrates the manner in which the geometric condition of FIG. 3 may be implemented to simulate the real viewing condition shown in FIG. 4;

FIG. 6 illustrates various intermodulations of spatial and angular resolution;

FIG. 7 depicts the influence of wavelength on the location of virtual image sources in a system operating in focal mode;

FIG. 8A is a perspective view of a microimage being imaged by a hexagonal microlens aperture;

FIG. 8B is a perspective view of a microimage magnified to an aerial image plane by a hexagonal microlens aperture, showing the overlap of a second magnified microimage similarly output from a neighboring lens system;

FIG. 9A is a side elevation of a lens showing the relationship between system length and nominal focal length in a convergent focal system;

FIG. 9B schematically illustrates the focal condition produced by the arrangement of FIG. 9A;

FIG. 10A illustrates the manner in which the lens shown in FIG. 9A may be employed to obtain an increased spatial resolution;

FIG. 10B schematically illustrates the focal condition produced by the arrangement of FIG. 10A;

FIG. 11A illustrates the manner in which the lens shown in FIG. 9A may be employed to obtain an even greater spatial resolution at a smaller magnification;

FIG. 11B schematically illustrates the focal condition produced by the arrangement of FIG. 11A;

FIG. 12 is side elevation showing graphic material on a film base applied to a microlens;

FIG. 13 is a side elevation showing graphic material on a relatively thin film base applied to a microlens in an inverted orientation;

FIG. 14 is a side elevation showing graphic material on a relatively thick film base applied to a microlens;

FIG. 15 is a side elevation showing two discrete microimage layers applied to a microlens so that two distinct focal conditions may be produced;

FIG. 16 schematically illustrates the effect of the two discrete microimage layers on viewing conditions;

FIG. 17A is a side elevation showing a positive photographic emulsion applied to a microlens with the conventional ordering of colors;

FIG. 17B is a side elevation showing a positive photographic emulsion applied to a microlens with the emulsion layers inverted,

FIGS. 18 and 19 are side sectional views of lens systems useful in the practice of the present invention;

FIG. 20 schematically represents quadratic conjugate fields in free space ahead of a lens array;

FIG. 21 illustrates the mosaic effect of intersecting quadratic fields as represented to an observer from a single viewpoint,

FIG. 22A illustrates how a region of the display including seven lenses might appear to the right eye of the observer indicated in FIG. 21;

FIG. 22B illustrates how a region of the display including the same seven lenses shown in FIG. 22A might appear to the left eye of the observer indicated in FIG. 21;

FIG. 22C illustrates the perceived optical output of the display, integrating the differing right-eye and left-eye views, when the parallax attributes of the stereoscopic image are reconciled by the eyes at a given distance from the display;

FIG. 23A is a side elevation of a gradient-index imaging lens;

FIG. 23B schematically illustrates the focal condition of the gradient-index imaging lens shown in FIG. 23A;

FIG. 24A shows a reinverting gradient-index lens;

FIG. 24B schematically illustrates the focal condition of the gradient-index imaging lens shown in FIG. 24A;

FIG. 25 is a schematic diagram of a microimage quantized into discrete pixels and arranged on raster grid; and

FIG. 26 is a perspective view of an aerial image created from microimages in accordance with FIG. 25.

### DETAILED DESCRIPTION OF THE PREFERRED EMBODIMENTS

A key aspect of the present invention involves the creation of overlap between the aerial image produced by each lens with those produce by its neighbors. The degree of overlap and the focal distance determine the primary characteristics of the three-dimensional image. In a particular quantized application, the mathematical product of the pixel size and the magnification factor of a lens array imaging system is smaller than the pitch of the individual lenses, producing a display having an identifiable spatial resolution greater than that of the lens array.

If the array's focal distance is relatively short, magnification is proportionally low and the aerial image is therefore relatively small, yielding relatively little overlap. The resulting small images have a high lateral spatial resolution, since they are not greatly magnified. In fact, at a 1:1 magnification, the aerial image consists of projected microimages that abut, and spatial resolution is limited only by the resolution of the backplane image. Such an image may have an extremely high resolution, but would not provide stereoscopic depth cues.

To provide stereoscopic depth cues, the invention is configured to have nonunitary magnification. Any overlap of the aerial microimages allows a given conjugate point in free space to be traversed by more than one source. The visual information apparent at a given point in space therefore depends upon a viewer's position, and the rate with which the information varies with a change in viewer position represents the angular resolution. This allows for simulated animation and stereographic three-dimensional display.

In general, the further the aerial image is located from the lens array, the more magnified it becomes, and the lower its lateral spatial resolution will be. However, a converse effect is observed in terms of angular resolution. As magnification increases, the magnified aerial image from a given lens increasingly overlaps with the images of each of its neighbors. The higher the magnification of the microimages, the greater the overlap, and consequently the higher the angular resolution will be. Accordingly, the magnification factor may be used to freely intermodulate the angular and spatial resolutions.

Stated differently, the further the focal plane is from the object plane, the greater will be the magnification of a pixel on the object plane (so that the resulting image has a lower lateral spatial resolution) but the more aerial images the point will appear in (resulting in higher angular resolution). If, for example, a locus in free space in front of a two-dimensional lens array lies within nine separate aerial images, projected by the an equal number of lenses (e.g. three horizontal and three vertical), then that locus can have a different appearance as seen from nine distinct regions of the display's view zone. Each lens thus contributes one sector to the total viewing field. In practice, these sectors can be very small divisions of viewing field, numbering, for example, in the thousands for a single locus in free space.

Varying the magnification therefore allows for a continuous tradeoff between these two fundamental display parameters. Common nonunitary magnification factors useful in the practice of the invention range from 1:8 to 1:100. It should be understood, however, that magnification factors outside this range may also be appropriate depending on the application, the type of display (image source) elected, or to the addition of devices such as a field lens within the optical pathway.

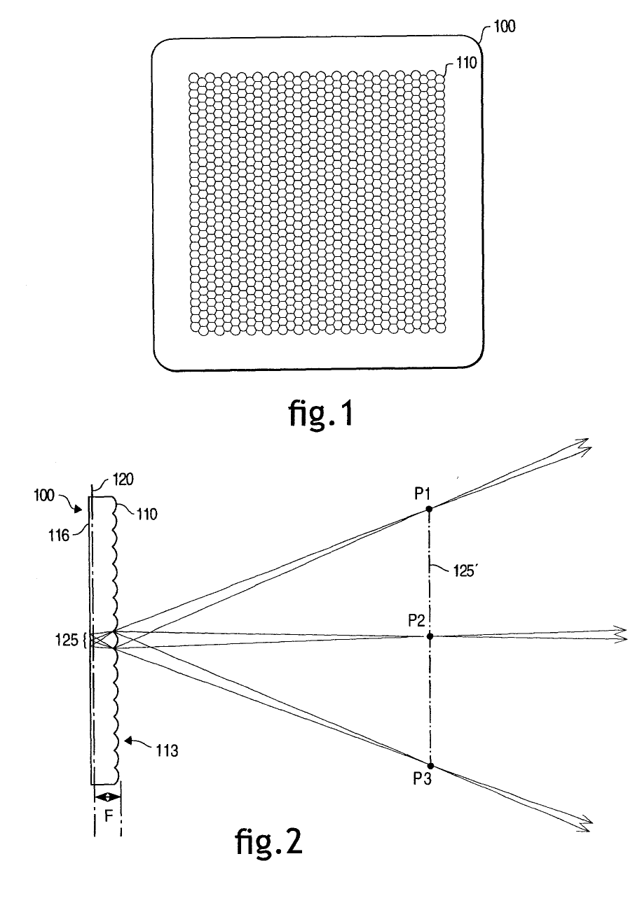

FIGS. 1 and 2 illustrate the structure and operation of a microlens array 100 including a plurality of individual, adjacent lens elements or systems 110. The figure is schematic, and is intended to include simple and layered refractive arrays, as well as gradient-index (GRIN), diffractive, or refractive-diffractive hybrid lens elements. Various component types may be included within a given system, and elements 110 may be cemented or otherwise spaced from one another. For simplicity of presentation, lens array 100 is shown as having a single convex refractive boundary 113, and the region between refractive boundary 113 and the graphic image backplane 116 is shown as if it were contiguously occupied by solid refractive material. In fact, as described below, this need not be the case. Moreover, in FIG. 1, the lens elements 110 are shown with hexagonal external apertures, and a 100% fill-rate is depicted. Once again, these factors may vary according to the application.

The lens systems 110 within lens array 100 are configured to project finite conjugate fields as overlapping magnified aerial images. Given a material of a particular refractive index, this implies a system length somewhat longer than that used in conventional, collimated microlens imaging based on such material. A shorter system length is possible if a material of higher refractive index is substituted. The focal plane which would provide collimated (rather than convergent) output is indicated at 120; the distance between focal plane 120 and refractive boundary 113 is given by F.

The visual information to be reproduced is coincident with image backplane 116. A portion (e.g., a microimage) 125 of this visual information associated with a given individual lens element is reproduced by that element as a magnified real image 125′ in free space. Points P1, P2, and P3 are representative finite conjugates. Accordingly, in a finite-conjugate system each microimage on backplane 116 yields a magnified real image projected to a corresponding location in free space. The width (w) of the microimage 125 is expanded to the width (W) of magnified real image 125′. The average magnification (M) of the microimage over width W is therefore W/w. In practice, the actual magnification can vary locally within the projected real image due to geometrical lens distortion. Shifting the system length from plane 116 to plane 120 can change the array from a system having finite conjugates, as shown, to a system having infinite conjugates (i.e., a collimated output).

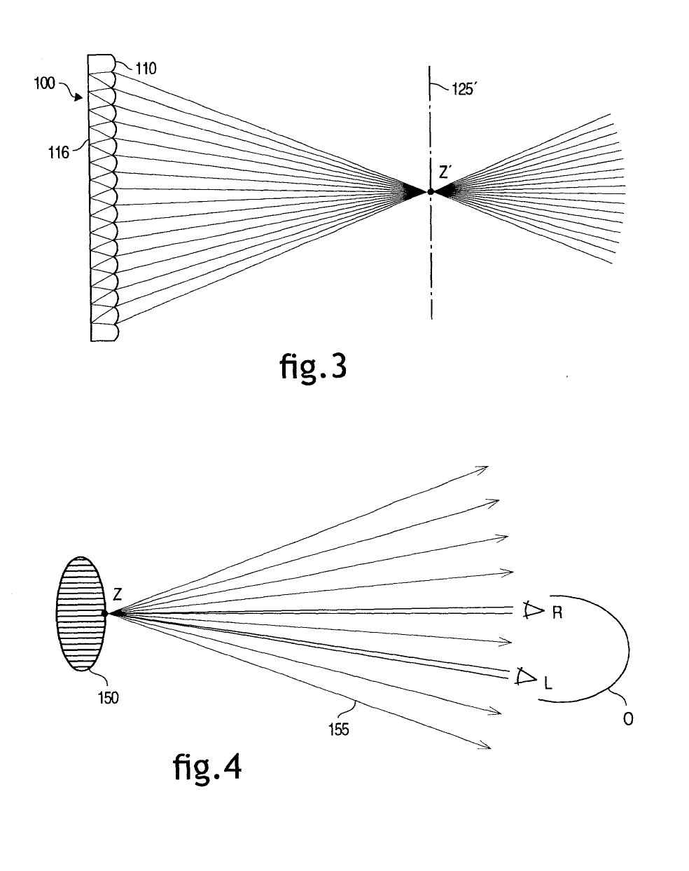

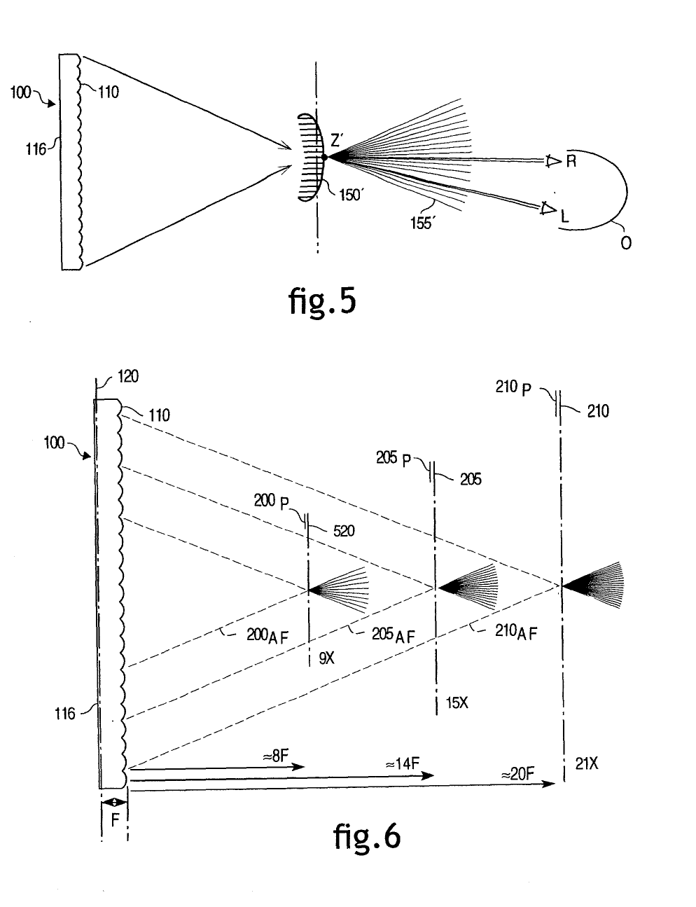

FIG. 3 illustrates how different image points accessible to a plurality of neighboring lenses can output light through a common locus Z′ in image 125′, and FIGS. 4 and 5 illustrate the manner in which this effect can be employed to produce stereoscopic images. FIG. 4 shows light emission from points on a real, three-dimensional object 150 in space as seen by human observer O. Rays 155 are emitted by each point Z on the surface of the object 150. The emission of light at diverse points is sampled at the pupils of the observer's right eye R and left eye L and converged on the retinas by ocular optics. The retinal images are then cognitively fused to produce a sense of stereoscopic depth.

As shown in FIG. 5, a suitably patterned graphic material disposed at backplane 116 can be reproduced by lens array 100 to form an image 150′ simulating object 150. That is, the point Z′ shown in FIG. 3 becomes one of many points collectively representing object 150′. So long as the observer's right and left eyes receive stereoscopically complementary renditions of object 150′, the object will be perceived in three dimensions. This effect requires both sufficient angular array resolution and separate microimages at backplane 116. The content and arrangement of the microimages are based on the known optical properties of a prefabricated lens array. For the purpose of illustration, point Z′ might be traced retrospectively through the optical system to various locations on the backplane of the display. If each pixel at these locations is assigned the color and luminosity of the simulated object at Z′, and this is reiterated for many points other than Z′, the collective effect of the microimages can simulate real object 150. Under these conditions, the ray subset 155′ appearing to emanate from Z′ simulates point emission Z from real object 150 in FIG. 4.

Only a static, monochromatic, matte object point, located precicely at the virtual source point in free space, will produce a constant color and intensity across the viewing range of the image. Accordingly, light directed at various angles through point Z′ from a plurality of microlenses may be graphically differentiated to the extent allowed by the angular resolution. In addition to facilitating encoding of distinct stereoimages, this angular resolution may be used, for example, to represent animation, or changes in surface qualities such as color, tone, transparency, or specularity. In other words, as the user moves and the right and left eyes intercept rays from different portions of the graphic image at backplane 116, the user perceives different (but stereoscopically matched) images that collectively represent the animation or other effect. The angular variation can also represent parallactic object geometries that will often depart from the projective locus identified by the neighboring lenses. In three-dimensional imaging, the virtual light source often appears to emanate from a location different from that suggested by the parallactic geometry of the represented object. This circumstance is indicated in FIG. 5, in that converged real image is shown as linear in section, while the simulated object is shown as convex.

The manner in which magnification can be altered to regulate intermodulation of spatial and angular resolution is illustrated in FIG. 6. This is accomplished by shifting backplane 116 while keeping the lens pitch (i.e., the center-to-center distance between lens elements 110) and the optical geometry of lens array 100 constant. When backplane 116 is located relatively close to plane 120, angular resolution is relatively high while spatial resolution is relatively low. When backplane 116 is located relatively far from plane 120, by contrast, angular resolution is relatively low while spatial resolution is relatively high.

For example, the near finite conjugate field 200 is magnified 9X and therefore accepts, along the vertical line shown, an angular contribution from only nine lenses as represented by angular field 200_{AF}. But the observed pixels, exemplified by near pixel 200ₚ, will be of relatively fine pitch (i.e., high spatial resolution) due to the low magnification. Conversely, the far conjugate field 210, with a magnification factor of 21X, can differentiate 21 views (i.e., accept images from 21 lenses along the illustrated vertical line) as indicated by far angular field 210_{AF}. However, as suggested by the relative size far pixel 210ₚ, the spatial resolution will be less than half that of the resolution at a magnification of 9X. The intermediate conjugate field 205, projected at a magnification factor of 15X, provides an intermediate solution via intermediate angular field 205_{AF} and intermediate pixel 205ₚ. The effective location of each conjugate field can depart from exact multiples of focal length F, as indicated by distances 8F, 14F, and 20F, and does not necessarily accord with nominal magnification.

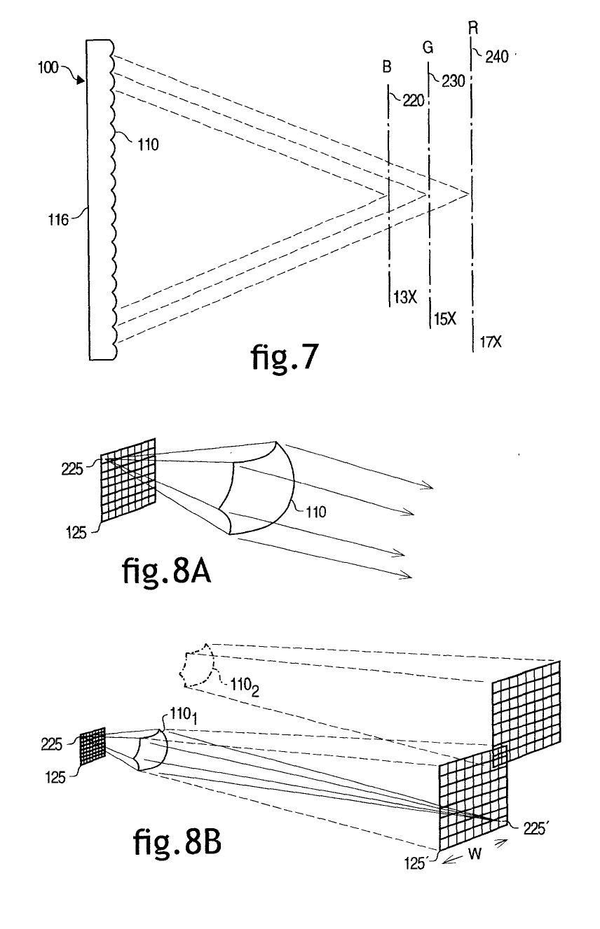

FIG. 7 depicts the effect of chromatic aberration on magnification. Many simple lens systems of the type commonly used in arrays exhibit axial chromatic aberration. In some embodiments of the invention, this can produce an effective variation of magnification due to differences in the frequency of the converged light. Thus, blue conjugate field 220, green conjugate field 230, and red conjugate field 240 dictate effective magnifications of 13X, 15X, and 19X for blue, green and red light, respectively. Image-processing calculations may therefore be made based upon a knowledge of these differing magnifications, and the intermodulation of spatial and angular resolutions may also be varied according the wavelength(s) of light being reproduced.

FIG. 8A shows a single hexagonal lens aperture and its associated microimage. The microimage need not have the same shape as the lens aperture. As indicated in FIG. 2, the lens elements define a common focal plane 120 and focal length F. Graphic image plane 116 is located at a distance greater than F. As shown in the figure, a microimage 125 (see FIG. 2) need not be continuous-tone, but may instead be comprised of a contiguous set of quantized image elements in the form of pixels, one of which is representatively indicated at 225. The number of pixels accessible to a given lens element 110 depends on the lens design. In the figure, lens element 110 is convex with a hexagonal emission aperture (see FIG. 1). Light from pixels accessible to lens element 110 is collected and directed toward a finite conjugate in free space. As shown in FIG. 8B, the conjugate fields of lenses 110 within the same vicinity may overlap at a location ahead of the array; that is, the magnified image 125′ of microimage 125 produced by lens 110₁ can overlap with the magnified image produced by neighboring lens 110₂. Pixel 225 is increased in apparent size as a direct function of the magnification factor M.

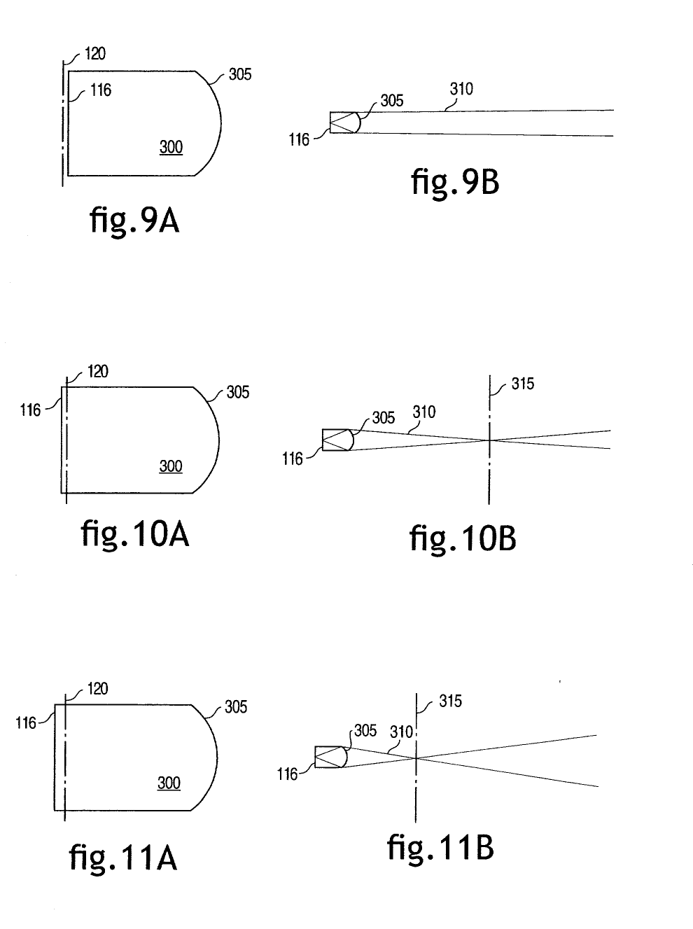

The design of the individual lens elements 110 can take different forms depending on the application. The basic optical considerations, discussed above in connection with the array, are illustrated in FIGS. 9A-11B at the level of lens elements. FIGS. 9A and 9B show generic planoconvex lens 300 operating in an afocal mode. The backplane 116 in such a case is slightly nearer to the lens aperture 305 than would be a backplane located at the focal plane 120, which would produce a collimated output. In this case, the rays 310 emitted by lens 300 are slightly divergent and have an associated virtual location well behind backplane 116.

Relocating backplane 116 behind focal plane 120 causes lens 300 to produce finite conjugates as shown in FIGS. 10A and 10B. Rays 310 converge ahead of the lens at a finite conjugate field 315. As demonstrated by FIGS. 11A and 11B, the finite-conjugate solution is not geometrically unique, and microlens system having finite conjugates can therefore be made to operate at diverse elective magnifications. Thus, locating backplane 116 even further behind focal plane 120 produces a smaller magnification and, hence, a smaller angular resolution but greater spatial resolution are achieved.

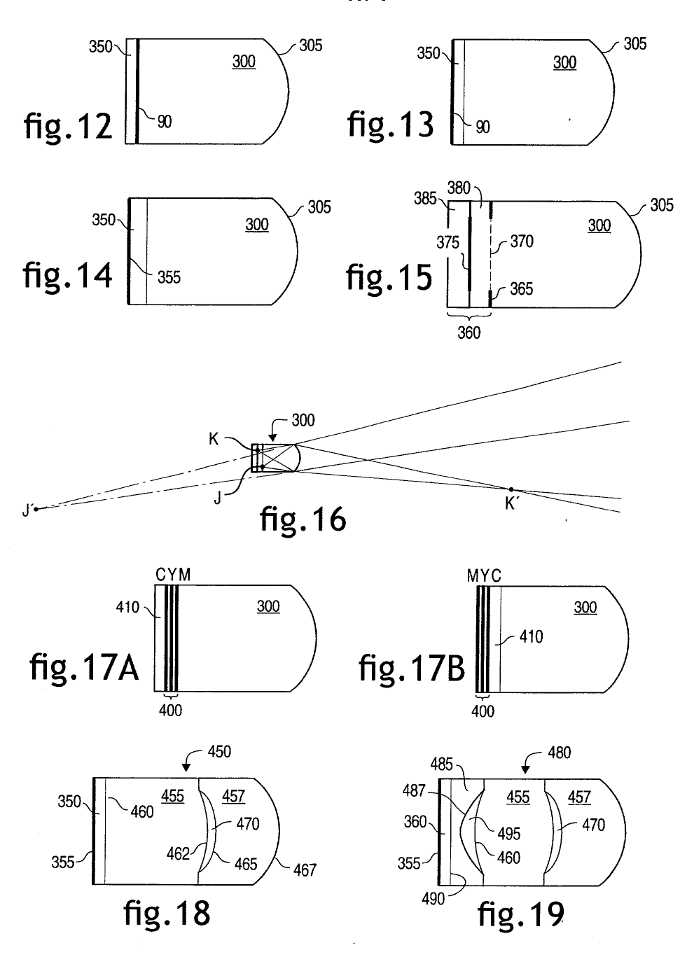

The effective location of backplane 116 can in many instances be varied without changing the structure of the lens itself. FIG. 12 shows a transparent film substrate 80 carrying a graphic material 355, such as a developed photographic emulsion or other image carrier. The graphic material 355 presents a microimage and is applied to the back planar surface of lens 300 to produce, for example, an afocal mode of operation. But by inverting the orientation of the film substrate 350, as shown in FIG. 13, it is possible to convert the afocal system to one having finite conjugates. This is analogous to a shift from the system shown if FIG. 9A to that shown in FIG. 10A. Thickening the film substrate 350 as shown in FIG. 14 locates the finite conjugate field closer to the surface of the array, in the manner shown in FIG. 11B.

FIG. 15 shows a lens 300 associated with a layered system of graphic material 360 that includes an outer dioramic microimage 365, a transparent region 370, and an inner dioramic microimage 375. Microimage 365 is carried on a transparent substrate 380, and microimage 375 is carried on an adjacent transparent substrate 380. Because of this layered structure, the system cam produce virtual light sources at distinctly separate locations as shown in FIG. 16. Graphic material at point J on microimage 365 appears to emanate from point J′ behind the array, while graphic material on microimage 375 optically emulates a location K′ ahead of the lens 300. Thus, layered graphic material can simulate diverse virtual source locations.

In FIG. 17A, lens 300 is associated with a developed color film 400 having a substrate 410 and a conventional series of cyan, yellow and magenta dyed emulsions indicated at C, Y, M. In the figure, the film 400 is arranged with shorter-wavelength emulsions progressively further from the rear planar surface of lens 300. But as shown in FIG. 17B, the color film 400 may simply be oriented (MYC) so that shorter wavelengths are produced closer to rear of lens 300. This inversion can reduce chromatic aberration, particularly when the lens pitch is relatively small, and increase the overall magnification of the image.

FIGS. 18 and 19 illustrate preferred lens-element designs suitable for use with the present invention. Lens element 450, shown in FIG. 18, has a design described at length in the '212, '298, '301, and '410 applications mentioned above. The illustrated lens geometry may be used to correct for spherical aberration, coma, and lateral color over an angular field of 50° or more. The lens 450 includes a pair of mating optical elements 455, 457 which, when lens 450 is part of an array, may be disposed on separate sheets that interfit owing to complementary topologies. Lens 450 includes a first optical member 455 having a rear planar surface 460 and a convex forward surface 462; the latter surface may be substantially spherical. A second optical member 457, optically coupled to member 455, includes a rear concave surface 465 and a forward convex surface 467; the former surface may be oblate. Surface 462 may be weaker in converging power than surface 467. These two surfaces generally do not meet, but instead are separated by an intervening region 470. While members 455, 457 are typically glass or an optical polymer (e.g., polycarbonate), region 470 is generally filled with a material such as air or a fluoropolymer having a lower refractive index. Members 455, 457 meet at the peripheral edge surrounding region 470, and in an array configuration, the peripheral edge may receive cement (which can block light) to hold the interfitting sheets together.

FIG. 19 illustrates a variation 480 of this lens which includes additional field-flattening optics near the plane of the graphic elements. In particular, the rear surface 460 of optical member 455 has a convex shape, and mates with a third optical member 485; this third member has a concave forward surface 487 and a planar rear surface 490. This negative-power feature also effectively eliminates lateral color and geometrical distortion. Once again, surfaces 460, 487 are separated by an intervening region 495, which is generally filled with a material such as air or a fluoropolymer having a lower refractive index.

For example, a lens as shown in FIG. 18 can have a pitch of 0.48 mm and a hexagonal aperture that provides an extended transverse field. A microimage in a 0.48 mm pitch system has one axial dimension equal to the lens pitch while the other may be extended to 0.6 mm to increase the viewing field. The extended field in three-dimensional applications would normally be aligned with the horizontal axis. Transverse angular viewing fields may be in the range of 40° to 60°. This type of array can readily be devised to usefully operate at magnification factors between 10X and 80X. If a magnification of factor of 40 is chosen, for example, magnified aerial microimages will each have a nominal maximum dimension of 24 mm. In the present case, the maximum number of lenses contributing to an aerial locus will therefore effectively be 24 mm÷0.48 mm, yielding an angular resolution of 50 divisions within the targeted viewing field. A common viewing field is around 50°, so the foregoing arrangement produces a different graphic aspect for approximately each degree in the viewing field.

Modulation transfer function (MTF) analysis of an exemplary lens array of this type indicates a 50% contrast modulation over the visible-spectrum across the quadratic projective surfaces at a resolution of 6 cycles/mm. Monochromatic MTFs are locally as high as 12 cycles/mm. A 6-micron microimage pixel may therefore be usefully magnified by a factor of 40 to produce an aerial pixel 240 microns across. The net linear image resolution of 0.24 mm may readily be understood to be twice the 0.48 mm pitch of the lens array. Other magnification factors will produce net image resolutions that can be greater or less than twice the lens pitch. Lateral chromatic aberration may be kept under 0.08 mm at the extremity of a 50° field. This aberration results in lateral color equal to one-third of a pixel. Lateral color equal to ⅓ of a pixel is commonly considered acceptable in projective systems of relatively low spatial resolution. Lateral color over the viewing field in this case would average approximately 0.030 mm, or only ⅛ of a 240 micron pixel.

Six-micron microimage pixels imply a layout of 100 horizontal pixels and 80 vertical pixels within each microimage field, permitting 8000 graphic elements to be optically accessed by each microlens cell. These graphic elements may be divided, as described herein, between the angular and spatial resolutions of the display.

As explained above, the magnification factor can be modified by adjusting the location of the lens-array backplane. In a polymer microlens array system, such adjustment may be achieved through simple adaptations of mold structures, attachment of one or more transparent layers to a prefabricated array, or regulation of adhesive thickness during bonding of an existing lens array to a graphic substrate.

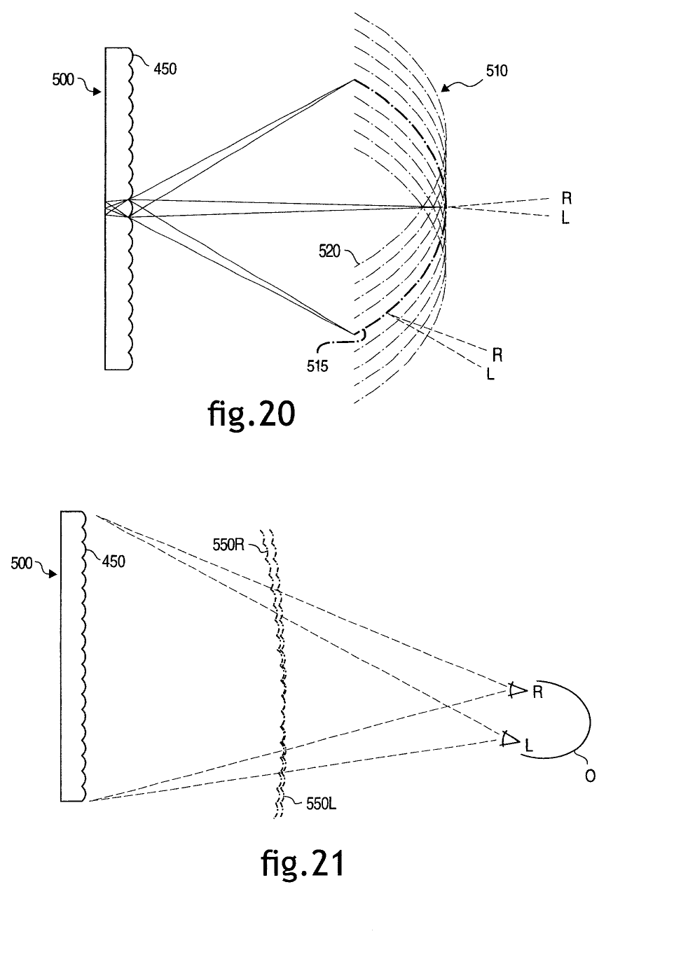

FIGS. 20 and 21 illustrate the manner in which an array 500 of lenses 450 (see FIG. 18) interacts with the visual system of an observer O. This configuration does not fully correct for field curvature, but instead projects a finite conjugate field to a series of curved quadratic surfaces 510 in free space. The quadratic surface indicated at 515 represents the conjugate field of a given lens 450 within the array 500. The overlapping quadratic field 520 represents a contributing finite conjugate field produced by a neighboring lens 450. In this case, the eyes will tend to accommodate to a virtual emission that diminishes in axial distance from the lens array 500 as the viewer's position departs from alignment with the optical axis of the observed microlens. This accommodation is suggested in FIG. 21 by the two postions of the right (R) and left (L) eyes of the observer O shown at two positions in the viewing field.

FIG. 21 shows the collective effect of the residual field curvatures on the observers view of the image. Each quadratic surface is sampled by the eye only over a narrow angular range. The sampled quadratic surfaces produced by the lenses 450 intersect, forming a mosaic virtual field that varies both in microscopic and macroscopic curvature, depending upon the location of the observer. The mosaic virtual fields 550R, 550L obtained by the right and left eyes, respectively, of observer O are depicted in two dimensions (in effect, sectionally) in FIG. 21. As indicated in the figure, there is little deviation in the location of the mosaic fields 550R, 550L perceived by the observer's two eyes, and therefore the visual system can accommodate to the image relatively little difficulty. But each of the mosaic fields may reproduce different visual material, e.g., complementary stereoimages. Moreover, because of the angular resolution of the lenses 450, the reproduced images may shift as the observer moves, thereby facilitating portrayal of motion or other animation. The presence of a degree of residual field curvature has a negligible effect on the ability of an observer to converge the image, but instead results in locally varying spatial and angular resolutions.

As in the case of axial chromatic aberration, lenses having residual field curvatures produce varied magnifications in the image-processing phase. A lens having a residual field curvature effectively varies locally in magnification, providing an angular resolution increasing toward the center of the viewing field and a spatial resolution at [typo] increasing at peripheral angular locations. While this arrangement causes the resolution of the viewed image to be somewhat indeterminate according to conventional quantification methods, the combined effects of the aerial mosaic conjugate field and varied magnification assist in the visual decorrelation of the images from the regular structure of the lens array 500. The failure to decorrelate the image from the display structure in many prior stereoscopic displays has often yielded a quantized, pixelated appearance that has detracted from the illusion of depth.

Furthermore, two-channel stereoscopic systems are known to optimally use asymmetric resolution values for the right and left eyes. Systems offering variations in perceived resolution can, in stereoscopic viewing conditions, provide more visual information and higher image quality than a graphic output having binocularly equalized resolution.

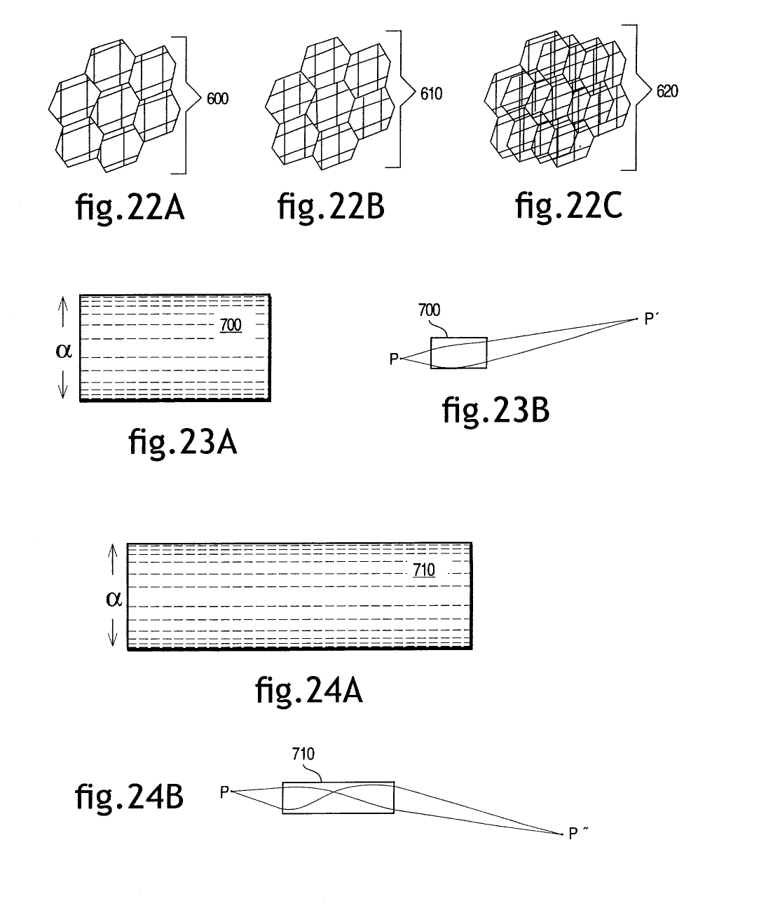

This is shown schematically in FIGS. 22A-22C. An array of lenses corrected according to the design of FIG. 18 can usefully resolve several pixels within an aperture of 0.5 mm. FIG. 22A shows a first observed mosaic finite conjugate field 600 (produced by lenses 450 with hexagonal apertures) having a lateral resolution approximately twice the lens pitch. FIG. 22B illustrates a slightly displaced conjugate field 610 reproducing the same visual material but having a local resolution approximately three times the microlens pitch. This is representative of conditions encountered using devices formed according to the invention, in which the perceived image structure differs for the right and left eyes. FIG. 22C schematically represents the conjoint graphic effect represented to the observer's retinas. This viewing condition differs greatly from, for example, that created by a conventional two-dimensional LCD panel. For a two-dimensional LCD display, the two eyes fix on a common image structure, and the black background grid surrounding the pixels is often discernible. In FIGS. 22A through 22C, a small area of an autostereoscopic image according to the invention is shown including seven lenses; each of the seven lenses includes a plurality of pixels. When the eyes converge on a stereoscopic image, the eyes angle inward to adjust to the object's parallax. The conjoint effect is represented in FIG. 22C, where the best image is obtained not by visually aligning the pattern of the lens outline, which is in practice difficult to visually resolve, but instead by responding to the graphic and optical characteristics of the projected pixels.

Unlike the cases of a conventional two-dimensional hard-copy image or electronic display, which presents the same image structure to both eyes, the visual impressions conveyed by conjugate fields 600, 610 are highly decorrelated. The cognitively fused visual data will be fragmentary, and are effectively stochastically dithered by the design of the array. This decorrelation of binocular views may be used, for example, to reduce moiré effects in electronic displays, or to produce an anti-aliasing effect either in the spatial or angular domain. Aliasing, which is a result of the quantization of visual data, can be encountered in the x, y, or z axis of a stereoscopic imaging system.

For example, research in holographic stereograms and image-based rendering has enabled quantification of the relationship between the number of intersecting ray directions (effectively, the number of view samples of the display) and the change in lateral spatial resolution as a function of distance from the focal plane. For displays formed according to the invention with little image overlap, and thus a small number of view samples per focal plane point, the maximum lateral spatial resolution falls off quickly as function of distance from the focal plane. For displays with a greater overlap, the maximum lateral spatial resolution falls off more slowly at distances further from the focus.

The maximum resolution limit at any depth plane of the display is given by the Nyquist theorem, which states, essentially, that to reproduce a high-quality signal, the signal amplitude must be sampled at a rate of at least twice its highest frequency component. In autostereoscopy, the required frequency component can vary according to the degree of parallax exhibited in a simulated object as the observer moves about in front of the display. The Nyquist theorem can be used to determine the point at which disagreeable visual effects, such as discontinuities on the outline of an object, are removed from the display. Exceeding the Nyquist limit leads to low-frequency aliasing artifacts in the three-dimensional image of the display. With this limit in mind, it becomes possible within the invention to either design a lens and display system to correctly image a particular object at a location in space, or to control the resolution of an object so that it can be displayed without aliasing artifacts.

An ideal simulation of three-dimensional space anticipates the adaptive optical capacity of a pair of human eyes. For example, when viewing a near object, an observer's eyes will point inwardly toward that location, and the flexible ocular lenses will concurrently be deformed to provide optimal retinal focus. Although individual viewers and observational conditions vary greatly, these two responses are ideally correlated to in systems that emulate scenes having depth. These optical properties can be integrated with the production of variable images that provide slightly differing parallax views, which may be cognitively merged to provide a sense of depth.

Because the projected real image field becomes the apparent source of illumination, it can be used to trigger cognitive and optical responses suggesting an object location ahead of the image actually reproduced by the microlens array. The lens array may be configured so as to place its one- or two-dimensional focus within the depth range of, or as close as possible to, the intended position of the displayed object. This focal configuration has several potential advantages over prior designs (particularly when using two-dimensional lens arrays). For objects restricted to a single depth plane that coincides with the array's focal plane, the image is located correctly in space, providing the viewer with accurate accommodation depth cues. For shallow objects near the focal plane, the display's focus approximates that of the object. Accommodation and the other depth cues provided by the display (stereopsis, motion parallax, occlusion) thus minimally conflict.

For a given object, a lens array and lens image recording process can be designed to meet particular imaging requirements (such as object position, lateral and longitudinal resolution and object depth) by varying physical parameters (lens and pixel pitch, location of focus). For a given lens array, limitations can be placed on the object being imaged and the imaging process in order to avoid image artifacts inherent to discrete imaging systems.

Nyquist analysis may be applied to the comprehensive capture of any display system so that unnecessary data can be minimized and the optimal image recorded for a given digital file size. The relative distance of objects in a scene can be obtained from any three-dimensional acquisition platform, whether it is by a dual or multi-camera system, by video, by structured light scanning, by sonar, or by optical holography. Once this depth information is known, and the display parameters are established in the manner herein described, the foreknowledge of the location of objects in simulated space relative to the actual location of the display can inform the digital coding of the visual data. Pixels may be clustered in blocks locally within a microimage, while in other areas in where frequency demands indicated by the Nyquist limit are higher, the microimage can exploit the maximum resolution of the display.

Systems designed or modified to accord with the teachings hereof can provide economies of data and cost. Systems optimized according to the invention can provide one or more of the following properties: an increase in the number of images of a given quality a still camera can hold in memory, an increase in rendering speed in computer-generated 3D software when outputting for subsequent sequencing or in real-time, decreases in the required speed of the graphic data-processing units, an increase in the frame rate of the display screen, an increase in the run time of a video sequence for a recording medium of fixed capacity, or a minimization of the requisite transmission bandwidth. These and other applications and combinations will be understood by those practiced in the arts of image processing, compression, and display.

The benefits of the invention may be obtained using lens designs other than those shown in FIGS. 18 and 19. For example, FIG. 24A shows gradient-index (GRIN) limaging lens 700 having a radial index gradient across the diameter α. FIG. 24B shows a point P imaged by such a lens to a conjugate finite point P′ in a nonunitary magnification. FIG. 24A shows an elongate GRIN lens 710 yielding a noninverted image. Similar noninverting rod lenses are commonly used in reimaging scanners, but may also be used to rectify pseudoscopy in autostereoscopic integral imaging systems.

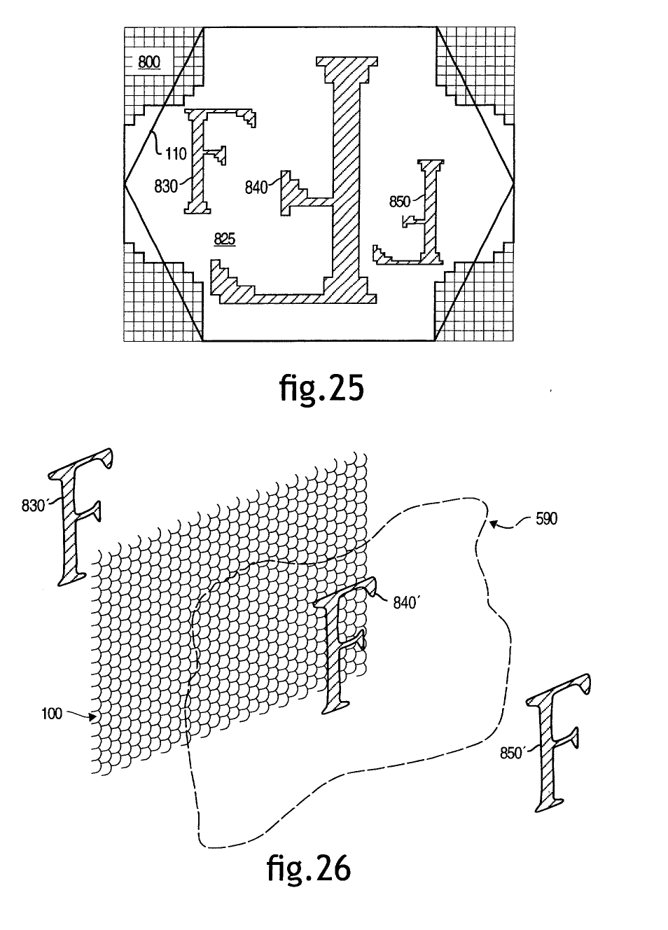

One use of the invention is detailed in FIGS. 25 and 26. FIG. 25 shows a microimage quantized into discrete pixels and arranged on raster grid 800. The graphic quanta may be dots generated by a film recorder or printing device, or may be discrete luminous elements in an emissive electronic display. The stepped microimage tile 825 is compatible with lens 110 and includes microimage icons 830, 840, and 850. In the figure, the microimage icons indicate objects which are to be imaged as objects of a common size and outline, but which are to be represented at differing depths within the autostereoscopic image.

This configuration is suggested by the perspective view in FIG. 26, where the apparent background object 830′, apparent intermediate object 840′, and apparent foreground object 850′ are generated, in accordance with the invention, by the collective effect of a plurality of microimage icons of the type shown in FIG. 25. Apparent background object 830′ appears to be behind lens array 100. Apparent intermediate object 840′ appears to be between the array surface and region 590 in free space associated with the combined right and left projective mosaic of quadratic fields shown in FIG. 21. Apparent foreground object 850′ appears ahead of region 590.

The autostereoscopic simulated objects 830′, 840′, and 850′ are generated, respectively, by representative icons 830, 840, and 850. To an observer, each autostereoscopic object produced by these icons has the same apparent size and orientation, but the generative microimage icons associated with the simulated objects can differ markedly in appearance from the apparent objects they optically reconstruct. This departure is indicated by the aliased outlines, inversions and scale variations indicated by microimage icons 830, 840, and 850 in FIG. 25.

Using the approach of the invention, and predetermined factors such as the apparent depth disparity, tolerable graphic resolution, and/or relative positions of objects in simulated space, display optics can be chosen or modified to avoid undesireable artifacts in the autostereoscopic image. For example, intermediate object 840′ appears relatively close to the lens array, and parallax shifts are therefore relatively small for a given degree of observer motion. Graphic resolution at the graphic backplane can therefore be relatively coarse, as indicated by the relatively lower spatial frequency of the stepping of the aliased outline of the icon.

Objects represented relatively far from the array surface (such as background object 830′ and foreground object 850′) will require relative greater backplane graphic resolution if they are to be displayed without spatial aliasing artifacts. The relatively fine resolution is indicated by the higher spatial frequency of the aliasing of the profiles of icons 830 and 850.

Given the disposition of simulated objects within the scene, it may be found that the requisite graphic resolution exceeds the capacity of a chosen output device. In accordance with the invention, the display and image processing may be adjusted to eliminate these artifacts. For example, transparent adhesive films for the bonding of optical materials are available in a variety of thicknesses. In many cases, the required higher spatial resolution might be obtained by electing a thinner adhesive-film substrate, and recalculating the underlying image accordingly. Alternatively, a lens array of the same thickness, but of lower optical power, may be utilized. In this case, the optical power may be regulated by the surface curvatures of the lens elements, or by the refractive index of the material.

The preceding example represents only one application; the approach may also be used to permit the same lens array molds to be used for low- and high-resolution graphic backplanes, e.g., for both LCDs and photographic transparencies. It can also allow spatial artifacts for a given set of parameters to be previewed and optimized on a conventional two-dimensional display. In this manner, the ideal optical configuration can be specified by the image designer in a way that produces the most effective and economical three-dimensional output.

It will therefore be seen that the foregoing represents a highly versatile approach to lens design and usage, permitting selection and intermodulation of spatial and angular resolutions. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A lens array comprising an array of lens elements having a backplane for reproducing an image located at the backplane, each lens having a nonunitary magnification and reproducing visual information from the backplane to a finite conjugate region in free space such that the reproduced visual information overlaps with visual information reproduced in free space by at least one neighboring lens element.

2. The lens array of claim 1 wherein the visual information is reproduced by the lens elements as a stereoscopic image.

3. The lens array of claim 1 further comprising a source of visual information on the backplane, the visual information comprising pixels each constituting a discrete component of visual information, each lens element producing an aerial image comprising multiple pixels simultaneously viewable at the conjugate region.

4. The lens array of claim 1 wherein the visual information produced in free space varies with a viewing angle, the lens elements having lens pitch defining center-to-center distances therebetween and cooperating to reproduce an image having a spatial resolution distinct from the lens pitch.

5. The lens array of claim 4 wherein the lens elements cooperate to reproduce an image having a spatial resolution greater than the lens pitch.

6. The lens array of claim 1 wherein the lens elements have magnifications ranging from 1:8 to 1:100.

7. The lens array of claim 1 wherein the lens elements cooperate to project a finite conjugate field to a series of curved quadratic surfaces in free space.

8. The lens array of claim 7 wherein quadratic surfaces produced by each of the lens elements intersect, forming a mosaic virtual field having locally varying spatial and angular resolutions.

9. The lens array of claim 8 wherein the lens elements have a residual field curvature so as to vary locally in magnification, the mosaic virtual field and varied magnification facilitating visual decorrelation of images individually produced by the lens elements.

10. The lens array of claim 1 wherein the lens elements have a residual field curvature so as to vary locally in magnification, the lenses providing an angular resolution increasing toward a center of a viewing field and a spatial resolution at increasing at peripheral angular locations.

11. The lens array of claim 10 wherein a degree of visual-information overlap determines a rate at which spatial resolution decreases with distance from the center of the viewing field.

12. A method of producing an aerial image in free space, the image having a spatial resolution and varying with viewing angle according to an angular resolution, the method comprising the steps of:
a. providing a lens array comprising an array of lens elements having a backplane and a nonunitary magnification, the lens array reproducing visual information to a finite conjugate region in free space, the spatial and angular resolutions of the image varying with the magnifications of the lens elements, visual information reproduced at the finite conjugate region by each lens element overlapping with visual information reproduced at the finite conjugate region by at least one neighboring lens element; and
b. selecting a magnification corresponding to a predetermined angular and spatial image resolution.

13. The method of claim 12 further comprising the step of varying a distance between the visual information and the backplane to vary the magnification.

14. The method of claim 12 wherein the visual information is reproduced by the lens elements as a stereoscopic image.

15. The method of claim 12 further comprising the step of providing a source of visual information on the backplane, the visual information comprising pixels each constituting a discrete component of visual information, each lens element producing an aerial image comprising multiple pixels simultaneously viewable at the conjugate region.

16. The method of claim 12 wherein the visual information produced in free space varies with a viewing angle, the lens elements having lens pitch defining center-to-center distances therebetween, the magnification causing reproduction of visual information at a spatial resolution distinct from the lens pitch.

17. The method of claim 16 wherein the spatial resolution is greater than the lens pitch.

18. The method of claim 16 wherein the selected magnification ranges from 1:8 to 1:100.

19. The method of claim 12 wherein the lens elements cooperate to project a finite conjugate field to a series of curved quadratic surfaces in free space.

20. The method of claim 19 wherein quadratic surfaces produced by each of the lens elements intersect, forming a mosaic virtual field having locally varying spatial and angular resolutions.

21. The method of claim 20 wherein the lens elements have a residual field curvature so as to vary locally in magnification, the mosaic virtual field and varied magnification facilitating visual decorrelation of images individually produced by the lens elements.

22. The method of claim 12 wherein the lens elements have a residual field curvature so as to vary locally in magnification, the lenses providing an angular resolution increasing toward a center of a viewing field and a spatial resolution at increasing at peripheral angular locations.

23. The method of claim 22 wherein a degree of visual-information overlap determines a rate at which spatial resolution decreases with distance from the center of the viewing field.
